(19) United States
(12) Patent Application Publication
(10) Pub. No.: US 2007/0141228 A1
(43) Pub. Date: Jun. 21, 2007

(54) Substantially sodium nitrate/nitrite free pork products and method for producing same

(75) Inventor: William P. Korleski, Clear Lake, IA (US)

Correspondence Address: DUNLAP, CODDING & ROGERS P.C., PO BOX 16370, OKLAHOMA CITY, OK, 73113, US

(73) Assignee: Mary Anne's Speciality Foods, Inc.

(21) Appl. No.: 11/604,473

(22) Filed: Nov. 27, 2006

Related U.S. Application Data
(60) Provisional application No. 60/750,762, filed on Dec. 15, 2005.

(51) Int. Cl. A23L 1/31

(52) U.S. Cl. 426/641

(57) ABSTRACT

Cooked, uncured pork products having an appearance and taste of cured pork products is provided wherein a brine solution is injected into the pork product and the pork products are smoked in a smokehouse using a plurality of stages wherein the pork products are heated to predetermined temperatures in the pressure of controlled humidity for a prescribed period of time. The cooked, uncured pork products are substantially free of nitrates and/or nitrites.

### CROSS-REFERENCE TO RELATED APPLICATIONS

This application claims benefit under 35 U.S.C. 119(e) of U.S. Ser. No. 60/750,762, filed Dec. 15, 2005.

### BACKGROUND OF THE INVENTION

1. Field of Invention

The present invention relates to uncured pork products having the appearance and taste of cured products, and more particularly but not way of limitation, to uncured ham and bacon products having an appearance and taste of cured ham and bacon products but which are substantially free of sodium nitrates and/or sodium nitrite. In one aspect, the present invention relates to a method for producing uncured pork products having an appearance and taste of cured products and which are substantially free of sodium nitrates and/or sodium nitrite.

2. Brief Description of Prior Art

A variety of additives have hereinbefore been used in the curing of pork products, such as ham and bacon. Of the various prior art additives used in curing pork products, nitrates and nitrites are the most frequently used. The major portion of pork is consumed, after curing, in the form of ham, bacon and sausages of many kinds. Nitrate is readily reduced to nitrite which is used directly in curing meats. It inhibits the growth of microorganisms, imparts a reddish pink color and a characteristic cured flavor to the meat. However, in the human body nitrates are converted into nitrosamines which have been shown to cause hepatse cell tumors in rats. Because of the concern about the presence of nitrite residues in meats, efforts have been made to reduce their use in curing of pork products and to increase the use of other chemicals, such as ascorbate and erythorbate which have been found suitable for this purpose. However, such other chemicals often provide the meat with undesirable characteristics including taste, color and texture. Therefore, the use of nitrates and nitrites has remained as important additives in the curing of pork products even though the presence of nitrites in cured products remained a suspected hazard.

### SUMMARY OF THE INVENTION

According to the present invention, uncured ham and bacon products are produced which have an appearance and taste of cured product and which are substantially free of nitrates and/or nitrites. More specifically, the present invention relates to an improved method for processing ham and bacon products utilizing a brine solution wherein the resulting uncured products are substantially nitrate and/or nitrite free and which have the appearance, texture and taste of cured products.

Broadly, an aqueous brine solution is formed which contains sea salt, raw sugar, sodium phosphate, vegetable juice concentrate and a nitrate and/or nitrite free fermenting agent. The nitrate and/or nitrite free fermenting agent can be mixed with a minor effective amount of distilled water prior to adding the nitrate and/or nitrite free fermenting agent to the brine mixture. Care must be exercised to utilize the brine solution containing the nitrate and/or nitrite free fermenting agent within a period of time wherein the fermenting agent remains active.

The aqueous brine solution is pumped into the ham and the brine treated ham is macerated to a depth of from about ½ inch to about two inches. The ham, which contains from about 20 to 32 weight percent of the brine solution, is then placed in a vacuum tumbler and vacuum tumbled for two hours utilizing sequences of on and off. The ham and the tumbler are then placed in a raw cooler and cooled to a temperature of from about 36° F. to 42° F. over night or for a period of time from about 8 to about 12 hours. The cooled ham and tumbler are removed from the raw cooler and the cooled ham is tumbled again for a period of from about 10 to about 15 minutes. Thereafter, the ham is removed from the tumbler and the ham is stuffed into a casing net which is desirably treated with a non-allergenic lubricant. A press tie or other typical tie is used to close off the end of the casing net and the ham is wiped off to remove any juice or brine from the outside of the ham after the ham is stuffed into the casing net.

The ham is then placed in a smokehouse and cooked in varying stages and at varying temperatures, at times in the presence of smoke and humidity, to provide the ham with an internal temperature of from about 150° F. to about 156° F. The cooking process is carried out for a period of time effective to produce a fully cooked, uncured ham substantially free of nitrates, i.e. the fully cooked ham, which has the appearance, taste and texture of a cured ham and which contains less than about one ppm nitrites.

In processing bacon, a brine solution is formed by admixing water, sea salt, raw sugar and a vegetable juice concentrate. A nitrate and/or nitrite free fermenting agent is mixed with a minor effective amount of distilled water, and the nitrate and/or nitrite free fermenting agent is then added to the brine solution. Care must be exercised to utilize the brine solution containing the nitrate and/or nitrite free fermenting agent within a period of time wherein the nitrate and/or nitrite free fermenting agent remains active. The mixture is then pumped into the bacon to provide the bacon with from about 5 to about 10 weight percent of the brine solution. Thereafter, the injected bacon is placed in the smokehouse and cooked at a dry temperature of about 140 to about 150° F. until the internal temperature of the bacon reaches from about 90° F. to about 110° F. and bacon is then held at those temperatures from about 1 to about 2 hours so as to continue cooking with the internal temperature of the bacon is from about 121° F. to about 126° F. The bacon so processed has the appearance and taste of cured bacon and is substantially free of nitrites, i.e. contains less than about one ppm nitrites. The smokehouse is maintained at a humidity of from about 20% to about 40% during the cooking process.

### DETAILED DESCRIPTION

The term “pump or pumping” when used herein is to be understood to mean injecting the brine solution into the meat so that the brine solution is distributed throughout the interior of the meat in order that the treatment can begin on the inside and proceed outwardly.

The term “raw sugar” as used to be understood to be unrefined cane sugar and/or cane sugar extracts, which contain molasses, such as Turbinado sugar, Muscovado sugar, Demerara sugar and mixtures thereof.

The term “nitrate and/or nitrite free fermenting agent” is to be understood to include non-fat dry milk, dextrose, lactic acid starter culture, ascorbic acid and mixtures thereof.

The term “vegetable juice concentrate” as used herein is to be understood to be any suitable vegetable juice concentrate capable of functioning as a food source for the nitrate and/or nitrite free fermenting agent, and which is compatible with the raw sugar, i.e., any vegetable juice concentration which functions as the food for the nitrate and/or nitrite free fermenting agent during the pork treatment process of the present invention. The vegetable juice concentrate can be either dry or liquid form. Examples of suitable vegetables which can be employed to provide the vegetable juice concentrate include, but are not limited to celery, beets, carrots and mixtures, with celery being the most desirable.

The term “sea salt” means a food grade, fine-screened, white crystalline sodium chloride manufactured by the natural evaporation of sea water. It is refined by washing with clean saturated brine to remove surface impurities, drained of excess moisture, dried and screened to size.

In order to provide a fully cooked, uncured ham utilizing the procedures of the present invention, a brine solution is formed containing from about 83 to about 87 weight percent water which is maintained at a temperature of from about 40° F. to 60° F., from about 6 to about 10 weight percent sea salt, from about 2 to about 6 weight percent of a raw sugar, from about 0.5 to 3 weight percent sodium phosphate, from about 0.5 to about 3 percent of a vegetable juice concentrate, preferably in a dried form, and from about 0.01 to about 1 weight percent of a nitrate and/or nitrite free fermenting agent.

While any raw sugar or raw sugar extract can be employed in the formulation of the brine solution employed in the practice of the present invention, especially desirable results have been obtained wherein turbinado sugar is employed as the raw sugar constituent of the brine solution. In addition, while any nitrate and/or nitrite free fermenting agent compatible with the brine solution and which is capable of carrying out the desired fermentation in ham or bacon can be employed in the fermentation of the brine solution employed in the practice of the present invention, desirable results have been obtained wherein the nitrate and/or nitrite free fermenting agent is lactic acid starter culture.

Once the brine solution has been formed, the brine solution is then pumped into the ham so as to provide the ham with from about 20 to about 32 weight percent of the brine solution. It is important to note that when mixing the nitrate and/or nitrite free fermenting agent with an effective minor amount of distilled water to substantially dissolve the nitrate and/or nitrite free fermenting agent and thereby provide an aqueous solution containing the nitrate and/or nitrite free fermenting agent, the aqueous solution containing the nitrate and/or nitrite free fermenting agent should be employed in formulation of the brine solution during the time period that the nitrate and/or nitrite free fermenting agent remains active. While this period of time can vary widely, but will generally be about one hour.

Once the ham has been injected with the brine solution containing lactic acid starter culture and the brine injected ham has been macerated, desirably to a depth of from about ½ inch to about 2 inches, the macerated, brine injected ham is placed in a vacuum tumbler for a period of from about 1 hour to about 2.5 hours, and more desirably about 2 hours, to extrude myosin and protein from the brine injected ham. The tumbler is activated to provide alternating “on” and “off” cycles. Desirably, the tumbler is activated in a cycle of about 20 minutes on and about 20 minutes off during the entire time that the ham is in the vacuum tumbler. Once it is determined that the ham contains the desired percentage of brine, i.e. from about 20 to about 32 weight percent, the ham and the tumbler are placed in a raw cooler and cooled overnight or for a period of from about 8 to about 12 hours to a temperature of from about 36° F. to about 42° F. The ham and tumbler are then removed and the ham is tumbled for an additional period of time of from about 10 to about 15 minutes. Thereafter, the ham is removed from the vacuum tumbler and stuffed into a casing net, such as a Jiff Pak® net (14 square) which is treated with a lubricant, such as silicone. The casing net is then clipped or tied and the outside of the ham is wiped off to remove any external liquids such as juice or brine. The ham is then placed in the smokehouse.

The cooking of the ham in the smokehouse is carried out in several stages, each of the stages having different temperatures. In the first stage, the brine solution impregnated ham is placed in the smokehouse and is heated at a dry temperature of from about 100° F. to about 130° F., desirable about 120° F., with the smoke off, until the internal temperature of the ham reaches a temperature of from about 90° F. to about 110° F. Once the internal temperature of the ham has reached a temperature of from about 90° F. to about 110° F., the ham is held at such temperature for a period of time of from about 15 minutes to about two hours to allow the lactic acid starter culture present in the brine solution to ferment. Once the fermentation has been accomplished, the second stage of the smokehouse is commenced.

In the second stage the temperature of the smokehouse is increased to a dry temperature of from about 145° F. to about 160° F., desirable about 149° F., with the smoke off. The ham is maintained under such conditions for about 30 minutes to about 1 hour, desirably about 45 minutes. Thereafter, stage three of the cooking procedure is implemented wherein the heat is increased to a temperature of from about 170° F. to about 190° F., desirably about 185° F., the humidity is maintained at about 20% to about 40% in the presence of smoke. The ham is maintained under the conditions of stage three until the internal temperature of the ham reaches from about 90° F. to about 110° F. Once the internal temperature of the ham reaches the temperature of from about 90° F. to about 110° F. the ham is maintained at such temperature for a period of time of from about 1 to about 2 hours, more desirably about 1½ hours.

At the end of the hold period, i.e. the maintaining of the internal temperature of the ham at the temperature of from about 90° F. to about 110° F. for a period of time of from about 1 to about 2 hours, the fourth stage of cooking is commenced wherein the dry temperature of the smokehouse to about 85° F. to about 100° F. for a period of time of from about 1 to about 2 hours desirably about 1.5 hours. The cooking of the ham during the fourth stage can be carried out in the presence of smoke if such is desired and/or necessary to maintaining the ham in a temperature of from about 90° F. to about 110° F. It should be noted that the smokehouse temperature may need to be reduced to about 85° F. to about 100° F. so the temperature does not rise.

After the completion of stage four, the cooking process enters stage five wherein the dry heat is increased to a temperature of from about 170° F. to about 200° F., desirably about 185° F., for a period of time of from about 5 to about, desirably about 10 minutes 20 minutes go to stage six. If desired, the cooking of the ham during stage five of the process can be carried out in the presence of smoke.

The sixth stage is implemented wherein the temperature of the smokehouse is increased and maintained at a temperature of from about 175° F. to about 200° F., desirably at about 185° F., and the humidity in the smoke house is maintained in the range of from about 40% to about 58% until such time as the internal temperature of the ham reaches a temperature of from about 150° F. to about 165° F., desirably from about 155° F. to about 156° F. and the ham has a caramel color. If desired, the cooking of the ham in stage six of the cooking process can be carried out in the presence of smoke. The ham is then removed from the smokehouse and allowed to cool for a period of time of from about 15 to about 30 minutes.

The ham produced in accordance with the procedures set forth above is an uncured, but fully cooked ham having the appearance, texture and taste of a cured ham. In addition, the ham is substantially free of sodium nitrates and/or sodium nitrites (i.e. contain less than about one ppm nitrites).

For producing fully cooked, uncured bacon which is substantially free of nitrates and/or nitrites and which has the appearance, texture and taste of cured bacon, a brine solution is prepared which contains from about 67 to about 71 weight percent water which maintained at a temperature in the range of from about 40° F. to about 55° F., from about 16 to about 20 weight percent sea salt, from about 8 to about 12 weight percent raw sugar, from about 1 to about 4 weight percent of a vegetable juice concentrate and from about 0.1 to about 1 weight percent of a nitrate and/or nitrite free fermenting agent. Prior to introduction of the nitrate and/or nitrite free fermenting agent into the brine solution the nitrate/nitrite fermenting agent is desirably admixed with an effective amount of distilled water to form an aqueous solution containing the nitrate and/or nitrite free fermenting agent. The brine solution containing the nitrate and/or nitrite free fermenting agent should be used during the period of time that the nitrate and/or nitrite free fermenting agent remains active, which is generally within one hour.

The brine solution so formed is pumped into a state of the bacon to provide the bacon with from about 5 to about 10 weight percent of the brine solution. Once the bacon has been injected, the brine injected bacon is subjected to a first stage wherein the brine injected bacon is placed in the smokehouse in contact with cold smoke for a period of time of from about 15 to about 20 minutes. Thereafter, the brine injected bacon is cooked in the smokehouse in a second stage for a period of time of from about 50 to about 70 minutes and at a dry temperature of from about 140° F. to about 150° F. in the presence of smoke. Once the second stage is completed, a third stage is commenced wherein the bacon is subjected to a dry temperature of from about 150° F. to about 160° F. and a humidity of from about 20% to about 30% until the internal temperature of the bacon is from about 120° F. to about 125° F. Thereafter, the bacon is subjected to heavy smoke to provide the bacon with a dark brown color.

The cooking of the ham and the bacon is desirably carried out in a conventional smokehouse. Once the bacon and hams have been thoroughly cooked, they are removed from the smokehouse, cleaned and ready for distribution.

In order to further illustrate the present invention, the following examples are given. It is to be understood that the examples are for illustrated purposes only and are not to be construed as limiting the inventive concept disclosed herein.

### EXAMPLE I

In order to provide a fully cooked, uncured ham having the appearance and taste of cured ham, but which is substantially free of nitrites, a brine solution was formed containing about 85 weight percent water which was maintained at a temperature of from about 40° F. to about 55° F., about 8 weight percent sea salt, about 4.5 weight percent turbinado sugar, about 1.5 weight percent sodium phosphate, about 1 percent of celery juice concentrate, in dried form, and about 0.03 weight percent lactic acid starter culture. The lactic acid starter culture was admixed with a minor effective amount of distilled water to dissolve the lactic acid starter culture prior to introducing the lactic acid starter culture into the brine solution. It is important to note that when mixing the lactic acid starter culture with an effective minor amount of distilled water and introducing the lactic acid starter culture into the brine solution that the aqueous solution of lactic acid starter culture and the brine solution containing the lactic acid starter culture should be used while the lactic acid starter culture remains active. Generally it is desirable to use the brine solution containing the lactic acid starter culture within about one hour from the time the solution is prepared.

The ham was then injected with an effective amount of the brine solution to provide the ham with about 27 weight percent of the brine solution. Thereafter, the brine solution impregnated ham was macerated to a depth of about two inches and the ham was placed in a vacuum tumbler for a period of about two hours. The tumbler was activated in a cycle of 20 minutes on and 20 minutes off during the time that the ham was in the vacuum tumbler. Once it was determined that the ham contained the desired percentage of brine (i.e. about 27 weight percent brine), the ham and tumbler were placed in a raw cooler and cooled overnight. The cool ham and tumbler were then removed and the cooled ham was vacuum tumbled for about 15 minutes. Thereafter, the ham was removed from the vacuum tumbler and stuffed into a Jiff Pak® net (14 square), which was treated with a silicone lubricant. The Jiff Pak® net was then tied using clips and the outside of the ham was wiped off to remove any external liquids. The ham was then placed in the smokehouse.

The cooking of the ham in the smokehouse was carried out in several stages, each of the stages having different temperatures. In the first stage, the ham containing the brine solution was placed in the smokehouse and was heated at a dry temperature of about 120° F. in the absence of smoke for about 30 minutes. The ham was then subjected to the second stage of the cooking process. In the second stage, the temperature of the smokehouse was increased to a dry temperature of about 149° F., in the absence of smoke, and the ham was cooked at the second stage temperature for about 45 minutes. Thereafter, stage three of the cooking process was implemented wherein the heat in the smoke house was increased to about 185° F., the humidity was increased to about 40%. The ham was maintained under the conditions of stage three until the internal temperature of the ham reached 95° F. to about 105° F. Thereafter, the ham was maintained at such temperature for about 90 minutes.

At the end of the 90 minute period, the fourth stage of the cooking process (i.e. the fermenting stage) was commenced wherein the dry temperature was maintained at 95° F., in the absence of humidity and the absence of smoke in order to maintain the temperature at 95° F. for about 1.5 hours.

After the completion of stage four, the cooking process entered stage five wherein the dry heat was increased to about 185° F., and the stage of the cooking process was carried out in the presence of smoke. The ham was cooked at such a temperature for about 10 minutes

The cooking process then entered stage six wherein the smokehouse was heated to a temperature of 185° F. and the humidity in the smokehouse was maintained at 47%. The ham was maintained in the smokehouse until the internal temperature of the ham reached 155° F. to 156° F. When the internal temperature of the ham had reached 155° F. to 156° F., the ham was removed from the smokehouse and allowed to cool for 20 minutes.

### EXAMPLE II

For producing fully cooked, uncured bacon having the appearance and color of cured bacon and which is substantially free of nitrates and/or nitrites, a brine solution was formed containing about 69 weight percent water, about 18 weight percent sea salt, about 10 weight percent turbinado sugar, about 2 weight percent powdered celery juice concentrate and about 0.7 weight percent lactic acid starter culture. The lactic acid starter culture was admixed with a minor effective amount of distilled water to dissolve the lactic acid starter culture prior to introducing the lactic acid starter culture into the brine solution. It is important that when mixing the lactic acid starter culture with an effective minor amount of distilled water and introducing the lactic acid starter culture into the brine solution that the brine solution containing the lactic acid starter culture, as well as the brine solution containing the lactic acid starter culture, should be used while the lactic acid starter culture remains active, such as generally within about one hour from the time the solution is prepared.

The brine solution was pumped into the bacon to provide the bacon with about 7 percent of the brine solution. Once the bacon was injected with the brine solution, the bacon was subjected to a first stage wherein the bacon was placed in the smokehouse in contact with cold smoke for a period of time of about 30 minutes. Thereafter, the bacon was cooked in a second stage for a period of about 60 minutes at a dry temperature of about 145° F. in the presence of smoke. Once the second stage was complete, a third stage was commenced wherein the bacon was subjected to a dry temperature of about 145° F. and a humidity of about 26% until the internal temperature reached about 122° F. Thereafter, the bacon was subjected to heavy smoke to provide the bacon with a dark brown color.

It should be noted that in smoking the bacon, a small amount of applewood was used. In addition, no washing of the bacon was required because no nitrates/nitrites were present.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. An aqueous brine solution for producing fully cooked, uncured hams substantially free of nitrates and nitrites free and wherein the hams have the appearance, texture and taste of cured hams, the brine solution comprising:
from about 83 to about 87 percent water, wherein the water is maintained at a temperature of from about 40° F. to about 60° F.;
from about 6 to about 10 weight percent sea salt;
from about 2 to about 6 weight percent raw sugar;
from about 0.5 to about 3 weight percent sodium phosphate;
from about 0.5 to about 3 weight percent of a vegetable juice concentrate; and
from about 0.01 to about 1 weight percent of a nitrate/nitrite free fermenting agent.

2. The aqueous brine solution of claim 1 wherein the raw sugar is selected from the group consisting of an unrefined cane sugar, cane sugar extracts which contain molasses and mixtures thereof.

3. The aqueous brine solution of claim 2 wherein the vegetable juice concentrate is selected from a group of vegetables consisting of celery, beets, carrots and mixtures thereof.

4. The aqueous brine solution of claim 3 wherein the vegetable juice concentrate is dried celery juice concentrate.

5. The aqueous brine solution of claim 2 wherein the raw sugar is an unrefined cane sugar.

6. The aqueous brine solution of claim 5 wherein the unrefined cane sugar is turbinado sugar.

7. The aqueous brine solution of claim 1 wherein the vegetable juice concentrate is dried celery juice concentrate.

8. The aqueous brine solution of claim 7 wherein the nitrate/nitrite free fermenting agent is lactic acid starter culture.

9. The aqueous brine solution of claim 1 wherein the nitrate/nitrite free fermenting agent is selected from the group consisting of non-fat milk, dextrose, lactic acid starter culture, ascorbic acid and mixtures thereof.

10. The aqueous brine solution of claim 9 wherein the nitrate/nitrite free fermenting agent is lactic acid starter culture.

11. An aqueous brine solution for producing fully cooked uncured bacon which is substantially free of nitrate and nitrites and wherein the bacon has the appearance, texture and taste of cured bacon, the aqueous brine solution comprising:
from about 67 to about 71 weight percent water wherein the water is maintained at a temperature of from about 40° F. to about 55° F.;
from about 16 to about 20 weight percent sea salt;
from about 8 to about 12 weight percent raw sugar;
from about 1 to about 4 weight percent of a vegetable juice concentrate; and
from about 0.1 to about 1 weight percent of a nitrate/nitrite free fermenting agent.

12. The aqueous brine solution of claim 11 wherein the raw sugar is selected from the group consisting of unrefined sugar, cane sugar extracts which contain molasses and mixtures thereof.

13. The aqueous brine solution of claim 12 wherein the raw sugar is turbinado sugar.

14. The aqueous brine solution of claim 13 wherein the vegetable juice concentrate is selected from the group of vegetables consisting of celery, beets, carrots and mixtures thereof.

15. The aqueous brine solution of claim 14 wherein the vegetable juice concentrate is dried celery juice concentrate.

16. The aqueous brine solution of claim 15 wherein the nitrate/nitrite free fermenting agent is selected from the group consisting of non-fat dry milk, dextrose, lactic acid starter culture, ascorbic acid and mixtures thereof.

17. The aqueous brine solution of claim 15 wherein the nitrate/nitrite free fermenting agent is lactic acid starter culture.

18. The aqueous brine solution of claim 11 wherein the vegetable juice concentrate is selected from the group of vegetables consisting of celery, beets, carrots and mixtures thereof.

19. The aqueous brine solution of claim 18 wherein the vegetable juice concentrate is dried celery juice concentrate.

20. The aqueous brine solution of claim 11 wherein the nitrate/nitrite free fermenting agent is selected from the group consisting of non-fat dry milk, dextrose, lactic acid starter culture, ascorbic acid and mixtures thereof.

21. The aqueous brine solution of claim 20 wherein the nitrate/nitrite free fermenting agent is lactic acid starter culture.

22. A method for producing fully cooked, uncured hams which are substantially nitrate/nitrite free and which have the appearance, texture and taste of cured hams, the method comprising the steps of:
providing a ham;
preparing an aqueous brine solution wherein the aqueous brine solution comprises:
from about 83 to about 87 weight percent water, wherein the water is maintained at a temperature of from about 40° F. to about 60° F.;
from about 6 to about 10 weight percent sea salt;
from about 2 to about 6 weight percent raw sugar;
from about 0.5 to about 3 weight percent of a vegetable juice concentrate; and
from about 0.01 to about 1 weight percent of a nitrate/nitrite free fermenting agent;
injecting an effective amount of the aqueous brine solution into the ham to provide a brine injected ham containing from about 20 to about 32 weight percent of the brine solution;
placing the brine injected ham in a vacuum tumbler for a period of time to extrude myosin and protein from the brine injected ham;
cooling the brine injected ham to a temperature of from about 36° F. to about 42° F. for a period of time of from about 8 to about 12 hours to provide a cooled, brine injected ham;
tumbling the cooled brine injected ham in the vacuum tumbler for an additional period of time of from about 10 to about 15 minutes;
removing the cooled brine injected ham from the vacuum tumbler;
cooking the brine injected ham in a smokehouse wherein the cooking comprises the following stages:
in a first stage the brine injected ham is placed in the smokehouse wherein the brine injected ham is heated at a dry temperature of from about 100° F. to about 130° F., in the absence of smoke, until the internal temperature of the brine injected ham reaches a temperature of from about 70° F. to about 80° F.;
holding the brine injected ham having the internal temperature of from about 70° F. to about 80° F. for a period of time effective to allow the nitrate/nitrite free fermenting agent present in the aqueous brine solution to ferment;
increasing the temperature of the smokehouse in a second stage of the cooking process to a dry temperature of from about 145° F. to about 160° F., in the absence of smoke, and cooking the brine injected ham at the dry temperature of from about 145° F. to about 160° F. for a period of time of from about 30 minutes to about 1 hour;
increasing the temperature of the smokehouse in a third stage of the cooking process of from about 170° F. to about 190° F. and cooking the brine injected ham, in the presence of smoke and a humidity of from about 20% to about 40% until the internal temperature of the brine injected ham reaches a temperature of from about 90° F. to about 110° F.;
maintaining the brine injected ham having an internal temperature of from about 90° F. to about 110° F. in the smokehouse for a period of time of from about 1 to about 2 hours;
providing the smokehouse with a dry temperature of from about 85° F. to about 100° F. for a period of time of from about 1 to about 2 hours;
increasing the temperature of the smokehouse in a fifth stage of the cooking process to a temperature of from about 170° F. to about 200° F. for a period of time to permit the internal temperature of the brine injected ham to reach a temperature of from about 150° F. to about 156° F.; and
removing a fully cooked, uncured ham from the smokehouse and allowing the fully cooked, uncured ham to cool whereby the fully cooked uncured ham has an appearance, texture and taste of a cured ham and the fully cooked ham is substantially free of nitrates and/or nitrites.

23. The method of claim 22 further comprising the step of macerating the brine injected ham prior to placing the brine injected ham in the vacuum tumbler.

24. The method of claim 23 wherein the brine injected ham is macerated to a depth of from about ½ inch to about 2 inches.

25. The method of claim 24 further comprising the steps of:
stuffing the cooled brine injected ham into a casing net; and
clipping the casing net to close the casing net about the cooled, brine injected ham.

26. The method of claim 22 further comprising the steps of:
stuffing the cooled brine injected ham into a casing net; and
clipping the casing net to close the casing net about the cooled, brine injected ham.

27. The method of claim 22 wherein the cooking process further comprises a sixth stage wherein the temperature in the smokehouse is increased and maintained at a temperature of from about 175° F. to about 200° F. and the humidity in the smokehouse is increased to a range of from about 40% to about 58% and the brine injected ham is maintained in such conditions until the internal temperature of the brine injected ham reaches a temperature of rom about 150° F. to about 156° F. and has a caramel color.

28. A method for producing fully cooked, uncured bacon which is substantially nitrate/nitrite free and which has the appearance, texture and taste of cured bacon, the method comprising the steps of:
providing a slab of bacon;
preparing an aqueous brine solution wherein the aqueous brine solution comprises:
from about 67 to about 71 weight percent water, wherein the water is maintained at a temperature of from about 40° F. to about 55° F.;
from about 16 to about 20 weight percent sea salt;
from about 8 to about 12 weight percent raw sugar;
from about 1 to about 4 weight percent of a vegetable juice concentrate; and
from about 0.1 to about 1 weight percent of a nitrate/nitrite free fermenting agent;
injecting an effective amount of the aqueous brine solution into the slab of bacon to provide a brine injected slab of bacon containing from about 5 to about 10 weight percent of the brine solution;
placing the brine injected slab of bacon in a smokehouse in the presence of cold smoke for a period of time of from about 15 to about 20 minutes;
cooking the brine injected slab of bacon in the smokehouse for a period of time of from about 50 to about 70 minutes at a dry temperature of from about 140° F. to about 150° F. in the presence of smoke;
subject the bacon to a dry temperature of from about 150° F. to about 160° F. and a humidity of from about 20% to about 40% until the bacon reaches an internal temperature of from about 121° F. to about 126° F.; and
subjecting the bacon to heavy smoke so as to provide the bacon with a dark brown coloring and having an appearance, texture and taster of cured bacon wherein the bacon is substantially free of nitrates and/or nitrites.
